(19) United States
(12) Patent Application Publication
(10) Pub. No.: US 2006/0127038 A1
(43) Pub. Date: Jun. 15, 2006

(54) Method and apparatus for modifying scheduled recordings

(75) Inventor: Young Sang Kwon, Seongnam-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/298,496

(22) Filed: Dec. 12, 2005

(30) Foreign Application Priority Data
Dec. 13, 2004 (KR) 10-2004-0104826

(51) Int. Cl. H04N 5/91

(52) U.S. Cl. 386/83

(57) ABSTRACT

A method and apparatus for modifying scheduled recordings when a scheduled recording entered by a user overlaps in time with one or more pre-stored scheduled recordings is disclosed. If a channel and recording duration for a new scheduled recording is entered by a user, it is determined if the duration of the new scheduled recording overlaps with one or more pre-stored scheduled recordings. If it is determined that there is a conflict, the user is automatically notified of the scheduled recording that overlaps in time with the newly entered scheduled recording, the overlapping scheduled recording is modified based on user input responsive to the notification, and the newly entered scheduled recording is added to the list of scheduled recordings, or if the user chooses to keep the pre-stored scheduled recording, the newly entered scheduled recording is modified or deleted.

### BACKGROUND OF THE INVENTION

This application claims priority to Korean Patent Application No. 10-2004-0104826 filed Dec. 13, 2004. The disclosures of the previous applications are incorporated by reference herein.

1. Field of the Invention

The present invention relates to a method and apparatus for a recording, a recording device, and more particularly, a method and apparatus for modifying scheduled recordings by a recording device.

2. Description of the Related Art

As the number of available TV channels increases, viewers use the scheduled recording capability of their recording apparatus frequently. Scheduled recording allows a program to be recorded between start and stop times on defined date and time so that the viewer can later watch the recorded program. In many cases, the mode of a scheduled recording, and a recording session begins automatically each time the specified time on the day of week set by the viewer is reached so that the program broadcast on a selected channel is recorded.

In some cases, the program that is broadcast regularly is replaced by a special program, e.g., a sport event, and instead of the user-set scheduled recording entries of the recording apparatus, the user may want to record the special program on another channel. When the user enters a one-time scheduled recording entry for recording a program on another channel, the one-time scheduled recording session may partly overlap in time with one or more pre-stored scheduled recording sessions. Once such a conflict occurs, the user is prevented from storing the new scheduled recording without modifying the pre-stored scheduled recording. The process for modifying previous entries and entering new entries is complicated, inconvenient and time consuming.

### SUMMARY OF THE INVENTION

An object of the invention is to solve at least the above problems and/or disadvantages and to provide at least the advantages described hereinafter.

In view of the shortcomings stated above, it is an object of the present invention to provide a method and apparatus for allowing users to easily resolve a recording schedule conflict caused when a new scheduled recording entry, which overlaps in time with some of pre-stored scheduled recordings, is entered.

The method for modifying scheduled recordings in accordance with the present invention determines if the recording duration of a scheduled recording that has been just entered by a user overlaps with the recording duration of a preset scheduled recording, accepts the just entered scheduled recording even if there is an overlap, and modified the preset scheduled recording based on input information received after storing the just entered scheduled recording.

In one embodiment, the preset scheduled recording is modified based on user input while the just entered scheduled recording is stored as valid information.

In another embodiment, the preset scheduled recording is modified automatically while the just entered scheduled recording is stored as valid information.

The objects and/or advantages can be achieved in a whole or in parts by a method for modifying scheduled recordings, comprising (a) determining if a recording duration of an entered scheduled recording overlaps with a recording duration of a preset scheduled recording, and (b) modifying the present scheduled recording based on input information while setting up the entered scheduled recording, if it is determined that there is an overlap in the step (a). If it is determined that there is an overlap in the step (a), the step (b) outputs a screen for receiving user input to modify the present scheduled recording and receives information through the screen, the screen being outputted automatically with no extra user input. Step (b) does not accept the entered scheduled recording as valid information if no modification is made to the present scheduled recording through the screen.

The objects and/or advantages can be achieved in a whole or in parts by a method for modifying scheduled recordings, comprising determining if a recording duration of an entered scheduled recording overlaps with a recording duration of a present scheduled recording, and modifying the present scheduled recording automatically while setting up the entered scheduled recording, if it is determined that there is an overlap in the step (a). If it is determined that there is an overlap in the step (a), the step (b) outputs a screen for querying whether to accept the entered scheduled recording with the present scheduled recording and modifies the preset scheduled recording automatically while setting up the entered scheduled recording if a request for accepting the entered scheduled recording is received, the screen being outputted automatically with no extra user input. Step (b) does not accept the entered scheduled recording as valid information if a request for canceling the entered scheduled recording is received. Step (b) modifies recording date of the present scheduled recording automatically. Step (b) automatically changes the recording date of the present scheduled recording to the next day if recording mode of the preset scheduled recording is set to daily recording. Step (b) automatically changes the recording date of the preset scheduled recording to the date of 7 days later if recording mode of the preset scheduled recording is set to weekly recording.

The objects and/or advantages can be achieved in a whole or in parts by an apparatus for recording/reproducing video signals, comprising a storage unit for storing scheduled recordings set by a user, and a control unit for determining if a recording duration of an entered scheduled recording overlaps with a recording duration of a preset scheduled recording stored in the storage unit and modifying the preset scheduled recording based on input information while storing the entered scheduled recording in the storage unit, if it is determined that there is an overlap. If it is determined that there is an overlap, the control unit outputs a screen for receiving user input to modify the preset scheduled recording and receives information through the screen, the screen being outputted automatically with no extra user input.

The objects and/or advantages can be achieved in a whole or in parts by an apparatus for recording/reproducing video signals, comprising a storage unit for storing scheduled recordings set by a user, and a control unit for determining if a recording duration of an entered scheduled recording overlaps with a recording duration of a present scheduled recording stored in the storage unit and modifying the preset scheduled recording automatically while storing the entered scheduled recording in the storage unit, if it is determined that there is an overlap.

If it is determined that there is an overlap, the control unit outputs a screen for querying whether to accept the entered scheduled recording with the preset scheduled recordings and modifies the preset scheduled recordings automatically while storing the entered scheduled recording in the storage unit, the screen being outputted automatically with no extra user input. The control unit automatically changes the recording date of the preset scheduled recording to the next day if a recording mode of the preset scheduled recording is set to daily recording. The control unit automatically changes the recording date of the preset scheduled recording to the date of 7 days later if a recording mode of the preset scheduled recording is set to weekly recording.

The objects and/or advantages can be achieved in a whole or in parts by a method for modifying scheduled recordings by a recording device, comprising, determining if a recording duration of new scheduled recording conflicts with a recording duration of preset scheduled recording, accepting the new scheduled recording by the recording device even if a conflict exists with the recording duration of at least one preset scheduling recording, and allowing at least one modification to at least one conflicting scheduled recording based on input information after the recording device stores the new scheduled recording.

The objects and/or advantages can be achieved in a whole or in parts by a method for modifying scheduled recordings by a recording device, comprising determining if a recording duration of a new scheduled recording conflicts with a recording duration of a preset scheduled recording, and if the conflicting new scheduled recording has a higher priority, automatically modifying the preset scheduled recording by the recording device to resolve the conflict.

The objects and/or advantages can be achieved in a whole or in parts by a recording/reproducing device, comprising a storage device to store information, a controller that controls the storage of information in the storage device, and performs at least one of the following control operation: (a) determining if a recording duration of new scheduled recording conflicts with a recording duration of preset scheduled recording, and accepting the new scheduled recording by the recording device even if a conflict exists with the recording duration of at least one preset scheduling recording, and allowing at least one modification to the at least one conflicting preset scheduled recording based on input information after the recording device stores the new scheduled recording, or (b) determining if a recording duration of anew scheduled recording conflicts with a recording duration of a preset scheduled recording, and if the conflicting new scheduled recording has a higher priority, automatically modifying the preset scheduled recording by the recording device to resolve the conflict.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIGS. 1A and 1B illustrate block diagrams of optical disk recording/reproducing apparatus

FIG. 2 illustrates a flowchart of a method for modifying scheduled recordings that overlap in time with each other in accordance with the present invention;

FIG. 3 illustrates an exemplary menu screen for editing scheduled recordings;

FIG. 4 illustrates an exemplary menu screen for resolving the problem of recording schedule conflicts in accordance with one embodiment of the present invention;

FIG. 5 illustrates a diagram of a method in accordance with the embodiment shown in FIG. 4;

FIG. 6 illustrates an exemplary menu screen for automatically resolving the problem of recording schedule conflicts in accordance with another embodiment of the present invention;

FIG. 7 illustrates a diagram of a method in accordance with the embodiment shown in FIG. 6;

FIG. 8 illustrates an exemplary menu screen for automatically resolving the problem of recording schedule conflicts in accordance with another embodiment of the present invention; and

FIG. 9 illustrates a diagram of a method in accordance with the embodiment shown in FIG. 8.

### DETAILED DESCRIPTION OF THE PREFERRED EMBODIMENTS

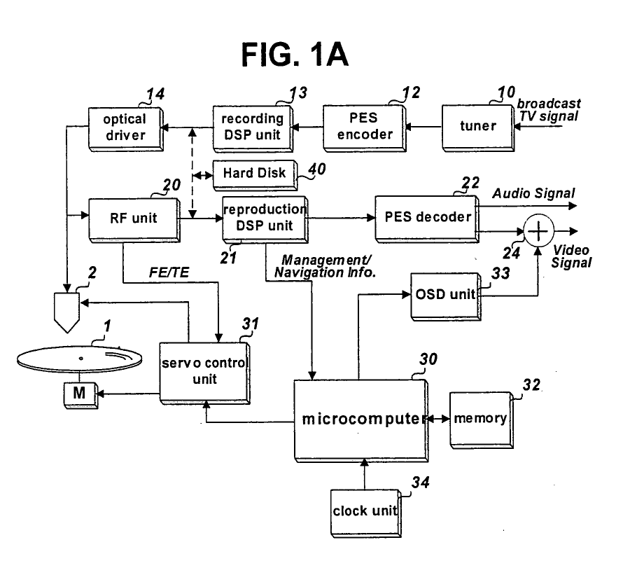

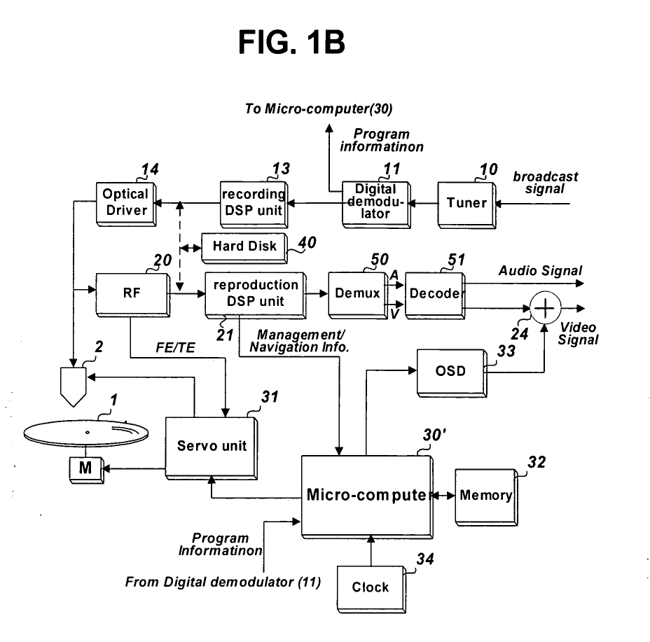

FIGS. 1A, and 1B illustrate block diagrams of various optical disk recording/reproducing apparatus embodying the present invention. The apparatus comprises a tuner 10, a PES encoder 12, a recording DSP 13, an optical driver 14, an optical pickup 2, an RF unit 20, a reproduction DSP 21, a PES decoder 22, an OSD unit 33, a mixer 24, a servo control unit 31, a memory 32, a clock unit 34, a microcomputer 30, and optionally a hard disk 40. The tuner 10 tunes to a requested TV channel. The PES encoder 12 digitizes the audio/video signals from the tuned channel, encodes the digitized signals in the MPEG format, converts the MPEG encoded data into PES (packetized elementary stream) packets, and multiplexes the audio and video PES packets. The recording DSP 13 organizes the sequence of PES packets into the ECC block format and modulates the data for recording.

The optical driver 14 provides electrical current to the optical pickup 2 according to the signal from the recording DSP 13. The optical pickup 2 reads signals recorded on an optical recording medium 1, e.g., a DVD+/−R disk, and records signals from the optical driver 14 on the recording medium 1. The RF unit 20 generates binary signals and focusing and tracking error signals from the signal from the optical pickup 2. The reproduction DSP 21 retrieves digital data from the binary signals and extracts management information and navigation information from the retrieved digital data. The PES decoder 22 demultiplexes data from the reproduction DSP 21 into audio and video PES packets and decodes each of the PES packets to generate audio and video signals.

The OSD unit 33 generates character and graphic signals to be overlaid on the main video image. The mixer 24 mixes the video signal from the decoder 22 with the character and graphic signals from the OSD unit 33. The servo control unit 31 controls the optical pickup 22 using the focusing and tracking error signals, controls the laser beams, and controls a spindle motor for rotating the optical recording medium 1. The memory 32 stores data such as the list of scheduled recordings. The clock unit 34 keeps track of the current date and time. The microcomputer 30 deals with user input and supervises the operation of the apparatus.

Optionally, if the hard disk 40 is present, the signal from the recording DSP 13 may be recorded to the hard disk 40. Once recorded on the hard disk 40, the signals may be retrieved by the reproduction DSP 21. The recording of the signal to the hard disk 40 may occur simultaneously or sequentially with the recording of the signal to the recording medium 1 dependent upon settings of the recording/reproducing apparatus. If signals are first recorded to the hard disk 40, the signals may then be rerecorded to the recording medium 1 after completion of the scheduled program based on settings or user input. Alternatively, the recording onto the hard disk 40 may be by-passed to record directly onto the recording medium 1, which may be an optical recording medium.

FIG. 1B shows an alternative embodiment. The new components of FIG. 1B, which are different from the apparatus of FIG. 1A, are: a digital demodulator 11 for demodulating digital data streams, for example, transport streams from the tuned signal and examining header information of transport packets in the transport stream; a demux 50 for demuxing transport streams from the digital data into encoded audio/video streams and extracting management and navigation information from the digital data; and an A/V decoder 51 for decoding the encoded audio/video streams and generating audio/video signals.

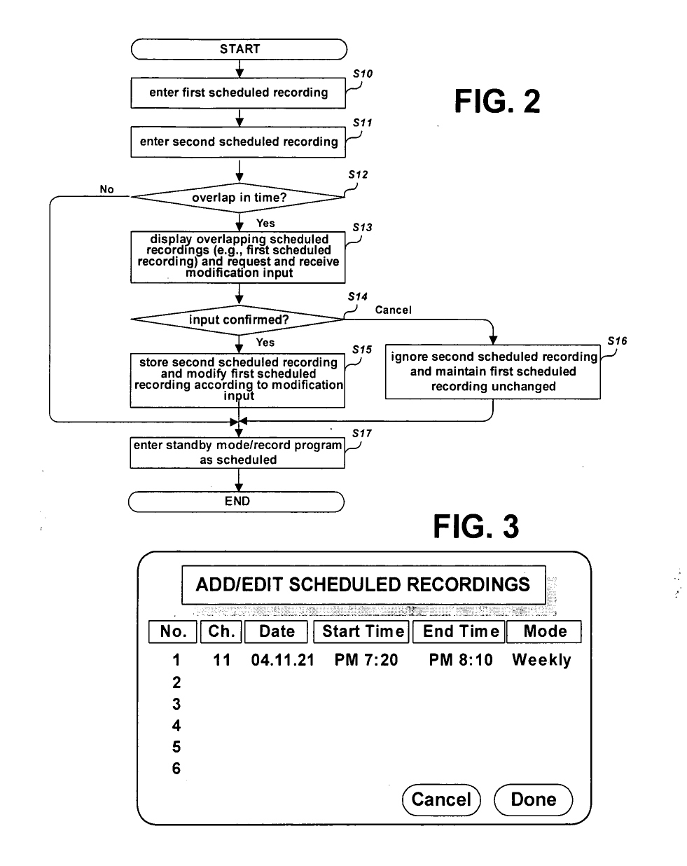

FIG. 2 shows an exemplary flowchart of an exemplary method for resolving recording schedule conflicts. As shown in FIG. 2, a user may enter at least one first scheduled recording into a recording apparatus (S10). Thereafter, at a later time, another schedule recording is entered (S11). Upon entry of the later (e.g. second) scheduled recording, it is determined if there is an overlap in time between any pre-existing (e.g., first) scheduled recording with the later scheduled recording being entered (S12).

If there is no overlap in time, the operation proceeds to have the apparatus enter a stand-by mode to wait for the recording start time and later record the scheduled recording (S17). Otherwise, if there is an overlap in time (in S12), an indication is displayed indicating the overlap in scheduled recordings and a request for modification is made and modification input is received (S13). Thereafter, the requested modification input is requested to be confirmed. If the input is confirmed, the second schedule recording and the modified first scheduled recording are stored (S15). Otherwise, if the input is not confirmed (in S14), the second schedule recording is ignored and the first schedule recording is maintained without changes (S16). Thereafter, the apparatus enters the stand-by mode to wait for the recording start time to record the program as scheduled (S17).

FIG. 3 shows a schedule recording menu screen according to an exemplary embodiment. The schedule recording menu screen preferably includes the recording item number (No.), a channel (Ch.), a date, including the day, a start time, an end time, and the record mode to indicate whether the scheduled recording is a once, daily, weekly, or any other type of recording. The menu screen also includes a button for canceling the add/edit operation or confirming completion of the operation.

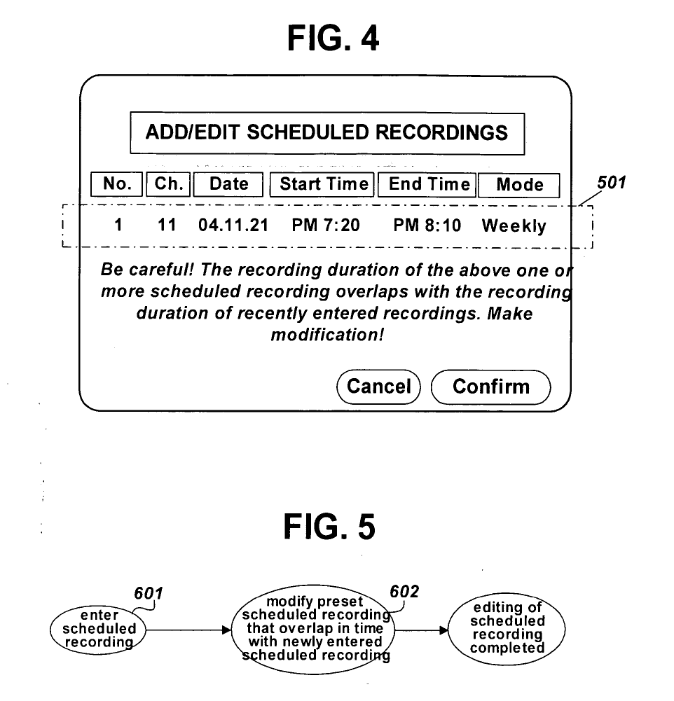

FIG. 4 shows an exemplary schedule recording menu screen showing a pre-stored scheduled recording 501 that conflicts with an added new scheduled recording. As shown in FIG. 4, the types of information displayed are similar to those of FIG. 3. However, a display message is shown requesting modification of the pre-stored scheduled recording 501 that conflicts. Additionally, a user may choose to press the cancel button to not proceed with the modification or choose to press the confirm button to proceed with the modification.

FIG. 5 shows an exemplary embodiment for modifying the pre-stored scheduled recording usable with the menu screen of FIG. 4. As shown in FIG. 5, when an added new scheduled recording is entered (601), a modification request appears as shown in FIG. 4. The user may then modify the pre-stored scheduled recording that overlap in time (602). Thereafter, the user completes the editing of the scheduled recording by either canceling or confirming the modification.

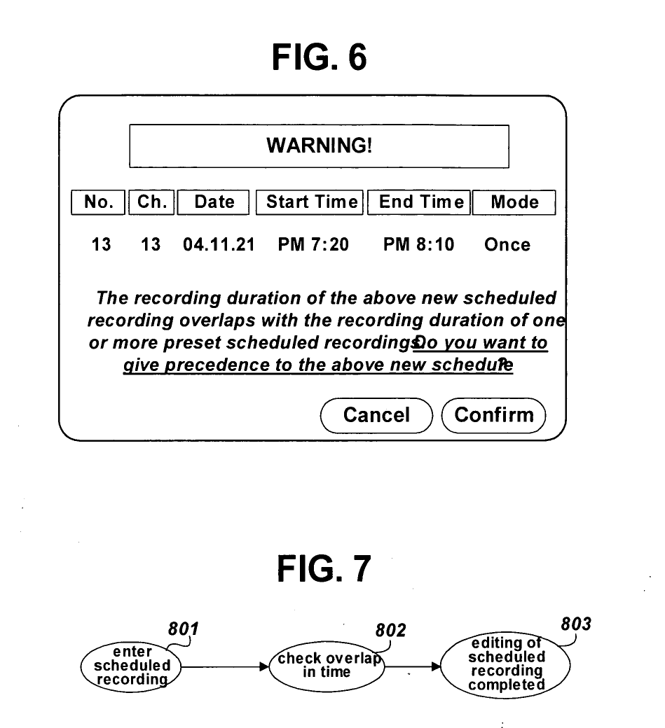

FIG. 6 shows another exemplary embodiment of a menu screen according to the invention. Instead of modifying the pre-stored schedule recording, a user may choose to give precedence to the pre-stored schedule recording or to the newly entered schedule recording. FIG. 6 shows the new scheduled recording. As shown, the menu has a button to cancel or confirm the precedence choice.

FIG. 7 discloses an exemplary method usable with the menu of FIG. 6. As shown in FIG. 7, when a user enters a new scheduled recording (801), a warning may be displayed (802) the new scheduled recording is displayed as shown in the menu of FIG. 6. The user may decide to give precedence to the new scheduled recording. The editing of the scheduled recording is completed (803) by either canceling or confirming the choice.

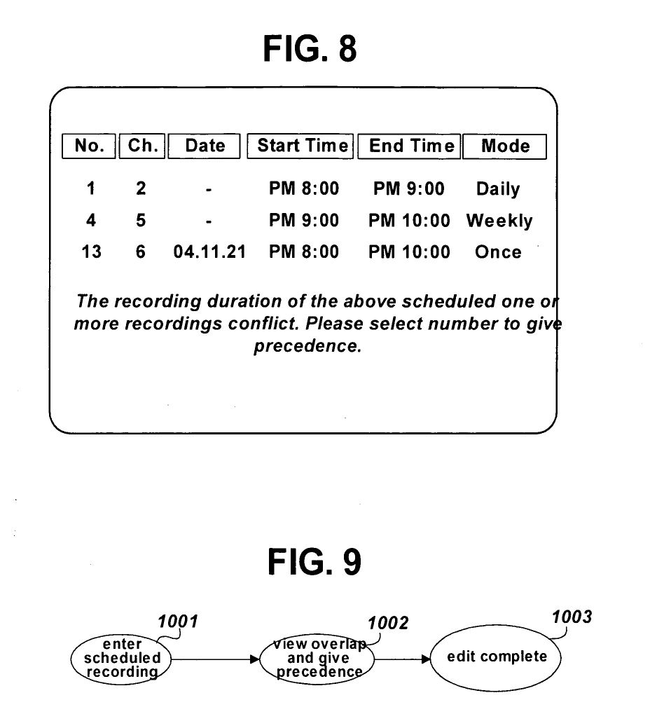

FIG. 8 shows another exemplary embodiment of a menu screen, which shows all the conflicting scheduled recording, including the pre-stored scheduled recording and the new scheduled recording. However, instead of merely giving precedence to either the pre-stored scheduled recording or the new scheduled recording, a user is able to choose the exact scheduled recording, whether pre-stored or new, that will be given precedence.

FIG. 9 shows an exemplary method usable with the menu of FIG. 8. As shown in FIG. 9, when a user enters a new scheduled recording (1001), a warning and all conflicting scheduled recordings are displayed (1002), as shown in FIG. 8. Once a user selects which of the schedule recording to give precedence, the edit is complete (1003).

The method for resolving scheduled recording conflicts will now be described in detail with reference to the flowchart shown in FIG. 2, the block diagram shown in FIG. 1, the menus shown in FIGS. 3, 4, 6 and 8, and the flow diagrams shown in FIGS. 5, 7 and 9.

If a user uses an input means, such as a remote controller, and selects a button for a scheduled recording menu, the microcomputer 30 controls the OSD unit 33 to output a scheduled recording menu screen, as shown in FIG. 3. The signal from the remote controller, which is typically an infrared signal, is received by an infrared receiving means and processed by the microcomputer 30. The user then enters information required for a scheduled recording such as, the channel, time (start and end times including date), recording mode (e.g., one-time, daily, weekly, etc) using the keys on the remote controller. The user completes the setting for the scheduled recording by selecting “done”, whereupon the microcomputer 30 registers the newly entered scheduled recording in the list of scheduled recordings stored in the memory 32 (S10).

Information about a scheduled recording marked one-time recording will be removed from the memory 32 after the associated program is recorded. However, information about a scheduled recording marked daily recording or weekly recording will remain in the memory 32 after the associated program is recorded because the recording operation will be performed repeatedly at the scheduled time of the next day or the next week. In such cases, the date to perform the next scheduled recording session is updated after every scheduled recording session.

When a scheduled recording marked weekly recording is added, the day of week as well as the date to perform the scheduled recording is stored in the memory 32. After completing the settings for scheduled recording, the optical disk recording/reproducing apparatus is placed in a standby mode, wherein every component except for the components needed for checking the time and receiving the power on/off requests is inactive, and thus, power consumption thereof is reduced significantly.

If the user wants to add a daily or weekly scheduled recording to the list of scheduled recordings at some time after the setting of the previous or first scheduled recording, the user turns on the disk recording/reproducing apparatus and selects again the scheduled recording menu. The microcomputer 30 then provides the menu screen as shown in FIG. 3 through the OSD unit 33. Using the menu screen, the user enters a new or second scheduled recording, such as a desired channel, scheduled recording time including date, and recording mode, and selects “done” (S11). It is assumed that the recording time includes the date and/or other information hereinafter.

Receiving the information, the microcomputer 30 determines if the new scheduled recording overlaps in time with some of the scheduled recordings in the list of pre-stored scheduled recordings stored in the memory 32. If it is determined that the new scheduled recording partly overlaps in time with one of daily, weekly, or other pre-stored scheduled recordings stored in the memory 32 (S12), the microcomputer 30 temporarily stores information of the new scheduled recording in the memory 32, displays a message indicative of the schedule conflict, and displays the pre-stored scheduled recording 501 that partly overlaps in time with the new scheduled recording, as shown in FIG. 4, thereby allowing the user to modify the setting of the pre-stored scheduled recording (S13).

For example, if the recording mode of the pre-stored scheduled recording is a daily recording and the recently entered recording is a one time occurrence, the user can change the recording date to the next day. If the recording mode is a weekly recording, the user changes the recording date to the next week, i.e., seven days later, and so on. If the recently entered recording is to permanently replace the pre-stored scheduled recording, this entry can be deleted.

When the user selects “done” (S14), the microcomputer 30 updates the list of scheduled recordings in such a way that the modification made by the user to the pre-stored schedule recording is reflected and the new scheduled recording stored temporarily in the memory 32 is included in the list of scheduled recordings (S15). As a result, the problem of overlapped scheduled recordings is simply resolved by modifying the pre-stored scheduled recording through a single step 602 using a single menu screen without performing the complicated steps. On the other hand, if the user selects “cancel” in the menu screen shown in FIG. 4 (S14), the microcomputer 30 ignores the temporarily stored information and maintains the list of scheduled recordings unchanged (S16).

In another exemplary embodiment, the modification can be made in a way different from the method using the menu screen shown in FIG. 4. For example, instead of automatically displaying the conflicting pre-stored scheduled recording to be modified, if a new scheduled recording partly overlaps in time with some of pre-stored scheduled recordings, the guide menu of FIG. 6 is displayed. The menu screen displays a message asking whether the user intends to give precedence to the new scheduled recording. If the user selects “confirm” from the guide screen shown in FIG. 6, it indicates that the user intends to ignore the pre-stored scheduled recording that conflicts and give precedence to the new scheduled recording. The microcomputer 30, therefore, adds the new scheduled recording to the list of scheduled recordings stored in the memory 32, and automatically modifies the pre-stored scheduled recording that overlaps in time in view of the new scheduled recording.

For example, if the pre-stored scheduled recording is a one-time recording, the pre-stored scheduled recording is deleted. If the recording mode of the pre-stored scheduled recording is a daily recording, the recording date is changed to the next day. If the recording mode thereof is a weekly recording, the recording date is changed to the next week, i.e., seven days later, and so on. In case of the one-time recording, it is also possible to record only the part of the pre-stored scheduled recording that does not overlap with the new scheduled recording session instead of deleting the pre-stored scheduled recording. In such a case, the pre-stored scheduled recording will be modified by having its start or end time, or other information, changed to not conflict with the new scheduled recording. FIG. 6 indicates the mode to be “Once”, but if the mode is “Daily” or “Weekly”, the user may instead replace the pre-stored scheduled recording with similar mode, and hence, the precedence to the new entry deletes such pre-stored scheduled recording. In the embodiment shown in FIG. 6, the user easily resolves the schedule conflict simply by selecting “confirm” 802 after entering information for the new scheduled recording 801, as shown in FIG. 7. On the other hand, if the user selects “cancel” in the menu screen shown in FIG. 6, the microcomputer 30 ignores the new information that has been temporarily stored show deletion and maintains the list of scheduled recordings unchanged. In an alternative embodiment, the new entry can be modified to avoid the conflict.

In another exemplary embodiment, all scheduled recordings that overlap, including the new schedule recording, are displayed and a choice is given to the user to choose from any of the pre-stored scheduled recordings or the new scheduled recording for precedence. For example, as shown in FIG. 8, the new scheduled recording (No. 13) overlaps with both the pre-stored scheduled recordings No. 1 and No. 4 for a weekly recording, although pre-stored scheduled recordings No. 1 and No. 4 themselves do not overlap. The user then uses the remote to mark or choose by number the desired schedule recording to give precedence to. If the new scheduled program is chosen, then the pre-stored scheduled recordings will be appropriately modified as discussed above. Otherwise, if the pre-stored scheduled recording is chosen, then the new scheduled recording is deleted. FIG. 9 shows the process graphically.

After completing the scheduling, the recording/reproducing apparatus is placed in the standby mode (S17). In the standby mode, the microcomputer 30 keeps examining if the current date and time falls within the time period of one of the scheduled recordings. If so, the microcomputer 30 puts the apparatus in normal mode and instructs the tuner 10 to tune to the channel to be recorded. At this point, a program time table of the tuned channel may be obtained. The microcomputer 30 controls the servo control unit 31 so that the optical recording medium 1 rotates at a desired rotational speed and the optical pickup 2 moves to a location when the scheduled recording session begins.

The video signal received from the tuned channel is MPEG encoded by the PES encoder 12 and then organized into PES packets. The PES packets are constructed into the ECC block format for error correction by the recording DSP 13 and recorded on the recording medium 1 by the optical driver 14 and optical pickup 2 after being modulated into signals for recording (S17). Alternatively, the signals may be recorded to the hard disk 40, when the scheduled recording session begins. Recording to the hard disk 40 may occur simultaneously, or alternately. If recorded to the hard disk 40 first, the program may be later re-recorded to the recording medium 1. The recording medium is preferably an optical disk.

The present invention provides a method and apparatus that allows a user to easily resolve recording schedule conflicts caused when the user enters a new scheduled recording that overlaps in time with at least one of pre-stored scheduled recordings. The recording schedule conflicts can be easily resolved without complicated and inconvenient modification steps.

As can be appreciated, the present invention is applicable to cable, satellite, internet or other wired or wireless transmission and reception.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for modifying scheduled recordings by a recording device, comprising:
determining if a recording duration of new scheduled recording conflicts with a recording duration of preset scheduled recording;
accepting the new scheduled recording by the recording device even if a conflict exists with the recording duration of at least one preset scheduling recording; and
allowing at least one modification to at least one conflicting scheduled recording based on input information after the recording device stores the new scheduled recording.

2. The method of claim 1, wherein the accepting step comprises allowing entry of every field associated with the new scheduled recording and storing in a memory.

3. The method set forth in claim 1, wherein if there is a conflict, automatically providing a subsequent screen only displaying at least one conflicting preset scheduled recording for allowing the at least one modification.

4. The method set forth in claim 1, wherein if there is a conflict, automatically providing a subsequent screen only displaying conflicting new scheduled recording for allowing at least one modification.

5. The method of claim 4, wherein at least one modification includes modification to the new scheduled recording.

6. The method of claim 4, wherein if no modifications are made, the new scheduled recording is determined to be invalid or undesired information, and the new scheduled recording is deleted.

7. A method for modifying scheduled recordings by a recording device, comprising:
determining if a recording duration of a new scheduled recording conflicts with a recording duration of a preset scheduled recording; and
if the conflicting new scheduled recording has a higher priority, automatically modifying the preset scheduled recording by the recording device to resolve the conflict.

8. The method of claim 7, wherein the conflict is resolved by changing a mode of the at least one preset scheduled recording.

9. The method of claim 7, further comprising:
accepting the new scheduled recording by the recording device even if a conflict exists with the recording duration of at least one preset scheduling recording.

10. The method of claim 9, wherein the accepting step comprises allowing entry of every field associated with the new scheduled recording and storing in a memory.

11. The method set forth in claim 7, wherein if there is a conflict, automatically providing a subsequent screen only displaying the at least one conflicting preset scheduled recording for determining a priority between the new scheduled recording and at least one conflicting preset scheduled recording.

12. The method set forth in claim 7, wherein if there is a conflict, automatically providing a subsequent screen only displaying the at least one conflicting preset scheduled recording and the new scheduled recording for determining a priority of displayed information.

13. The method set forth in claim 7, wherein if a request for canceling the entered scheduled recording is received, the new scheduled recording is deleted.

14. The method set forth in claim 8, wherein the mode is automatically changed by changing the recording date of the preset scheduled recording to the next day if the mode of the preset scheduled recording is set to daily recording.

15. The method set forth in claim 8, wherein the mode is automatically changed by changing the recording date of the preset scheduled recording to the date of 7 days later if the mode of the preset scheduled recording is set to weekly recording.

16. The method of claim 4, further comprising:
allowing a user to select and retain either the conflicting at least one present scheduled recording or the new scheduled recording.

17. A recording/reproducing device, comprising:
a storage device to store information;
a controller that controls the storage of information in the storage device, and performs at least one of the following control operations:
(a) determining if a recording duration of new scheduled recording conflicts with a recording duration of preset scheduled recording; and accepting the new scheduled recording by the recording device even if a conflict exists with the recording duration of at least one preset scheduling recording; and allowing at least one modification to the at least one conflicting preset scheduled recording based on input information after the recording device stores the new scheduled recording; or
(b) determining if a recording duration of a new scheduled recording conflicts with a recording duration of a preset scheduled recording; and if the conflicting new scheduled recording has a higher priority, automatically modifying the preset scheduled recording by the recording device to resolve the conflict.
